(19) United States
(12) Patent Application Publication
(10) Pub. No.: US 2025/0319844 A1
(43) Pub. Date: Oct. 16, 2025

(54) Method and Device for Controlling Access to a Motor Vehicle

(71) Applicant: Bayerische Motoren Werke Aktiengesellschaft, Muenchen (DE)

(72) Inventors: Michael FURCHNER, Mering (DE); Thorsten Knott, Tuntenhausen (DE); Daniel Kuelzer, Muenchen (DE)

(21) Appl. No.: 19/077,121

(22) Filed: Mar. 12, 2025

(30) Foreign Application Priority Data
Apr. 12, 2024 (DE) 10 2024 110 392.2

(51) Int. Cl. B60R 25/31

(52) U.S. Cl. CPC B60R 25/31

(57) ABSTRACT

The present disclosure relates to a method and a system for access control of a motor vehicle. In one form, the method includes the steps of detecting an approach of a user terminal to a motor vehicle, detecting an input of a user at the user terminal, detecting that the user has not been authenticated, and unlocking and/or opening the motor vehicle based on the approach and the input.

### CROSS REFERENCE TO RELATED APPLICATION

This application claims priority under 35 U.S.C. § 119 from German Patent Application No. 10 2024 110 392.2, filed Apr. 12, 2024, the entire disclosure of which is herein expressly incorporated by reference.

### BACKGROUND AND SUMMARY

The invention relates to a method and a device for controlling access to a motor vehicle.

The present disclosure includes solutions for enabling access and, in particular, access control to a vehicle using a so-called smart device. This is usually done after a user has been authenticated on the smart device.

DE 10 2015 223 342 A1, for example, discloses a method for operating an authorization device for a vehicle, which is designed for initial communication with the vehicle and has a locating unit designed to determine a current location of the authorization device. In the method, the authorization device is provided with a locking location that is representative of a location of the vehicle at which a last locking operation of the vehicle was performed. The tracking unit is set to an operation that determines the current location of the authorization device for at least a predetermined period of time. Depending on the current location and the locking location, a communication operating state of the authorization device is controlled. In the event that the authorization device is in the communication operating state, a first authorization signal is provided for operating the vehicle by means of the first communication.

It is therefore an object of the present invention to provide an improved method and a device for controlling access to a motor vehicle. In particular, it is an object of the present invention to provide an improved method for unlocking and/or opening a motor vehicle.

In accordance with forms of the invention, this object is achieved by the subjects of the independent claims. Advantageous embodiments of the invention are the subject of the dependent claims and the description.

According to a first aspect, a method for controlling access to a motor vehicle is provided.

In one form, a method comprises the steps of detecting an approach of a user terminal to a motor vehicle, detecting an input of a user at the user terminal, detecting that the user has not been authenticated, and unlocking and/or opening the motor vehicle based on the approach and the input.

In some implementations, the method is used in particular to unlock and/or open a motor vehicle with the aid of a user terminal without a user having actively authenticated themself beforehand, but without sacrificing security.

A user terminal is a unit or a device that is designed to receive user inputs and/or user commands and to communicate with a motor vehicle, in particular in order to provide these user inputs to the motor vehicle.

In particular, the user terminal is a portable or mobile device that is different from the motor vehicle and can be designed in particular as a so-called smart device, i.e., as a device with at least one processor device, such as a smartphone, a phablet or a tablet, a smart watch, smart glasses and/or a wearable, which also provides other functions, such as telephoning, surfing the Internet or news services, for example through apps or programs.

Alternatively or additionally, however, the user terminal can also be designed as a proprietary device, such as a physical key, a fob and/or a radio remote control, which is designed solely to carry out or at least effect or support the steps explained here in connection with the method according to the invention, in particular in interaction with the motor vehicle, as will be described below.

In particular, the user terminal is designed to perform one or more functions in relation to one or more motor vehicles, such as locking and/or unlocking one or more doors and/or flaps and, in particular, actively opening and/or closing one or more doors or flaps.

Such functions or interactions with the motor vehicle, in particular those that enable access to or unlocking of the motor vehicle, can also be referred to as secure and/or protected functions and are supported or implemented in particular by a secure module in or from the user terminal. Such a secure module can contain both hardware components, for example in the form of a secure processor and/or a secure memory region, and software components, for example one or more apps or programs, which work together.

For this purpose, the user terminal is typically coupled to the at least one motor vehicle, so that the user terminal is known to the motor vehicle, is registered to it and/or, in particular, is authorized to perform or initiate the functions described above and also other functions on the motor vehicle. In particular, the user terminal has a digital access key for this purpose, which is also, in particular exclusively, stored and/or processed in the secure module, for example.

In order to perform such secure functions, such as unlocking the vehicle, a user must normally or typically identify and/or authenticate themself. In particular, the user must prove their authorization or at least grant the user terminal and thus also the motor vehicle the possibility of identification and/or authentication.

The user is, for example, the owner, possessor, keeper, authorized user and/or a driver or passenger of the motor vehicle and also of the user terminal and, in particular, is regularly and/or permanently authenticated to perform or effect these functions by the user terminal.

The user can be authenticated in this way by entering a PIN, password or passcode, in particular a predefined one, which can be alphanumeric, for example. This can, for example, be entered via one or more suitable input devices on the user terminal, such as an on-screen keyboard.

Alternatively or additionally, such authentication can be carried out biometrically in particular, for example by recognizing or identifying the user via a part of the body, such as the eyes, in particular the retina, a face and/or a fingerprint. This can be done using one or more suitable sensors on the user terminal, such as a camera and/or a fingerprint sensor.

In any case, the present invention takes into account a scenario in which a user cannot authenticate themself and/or cannot authenticate themself in time or at the desired time and/or in the desired manner.

This can be the case in particular if the user uses one or more hands, for example because they are carrying luggage and/or a purchase, and therefore have no way of removing the user terminal from a pocket/bag, such as a trouser pocket and/or handbag.

This can also be the case if the user is in a particular hurry and is carrying the user terminal but cannot find it, for example because it is placed in a trouser pocket and/or handbag with several other items.

The first step is to detect the user terminal approaching the vehicle.

Approaching means approaching and in particular entering a, in particular predefined, distance from the motor vehicle, such as approaching to within 50 m, 25 m, 15 m, 10 m or 5 m of the motor vehicle. In particular, approaching comprises entering a range of one or more wireless transceivers, such as one or more Bluetooth transceivers, which are arranged on and/or comprised by the motor vehicle.

The approach of the user terminal to the motor vehicle can also take place in particular via triangulation and/or time-of-flight measurements between one or more transceivers of the motor vehicle and one or more transceivers of the user terminal.

In particular, one or more transceivers of the motor vehicle and one or more transceivers of the user terminal communicate regularly or periodically and exchange data and/or information, in particular via one or more wireless communication protocols. The wireless communication protocol may in particular be one or more of Bluetooth, in particular Bluetooth low energy or LE, NFC, RFID and/or WLAN.

In particular, the motor vehicle and/or the user terminal regularly or periodically detects whether and to what extent one or more devices, including the other one of them, have approached.

In particular, approaching the user terminal to the motor vehicle also triggers the method or starts the method with this step.

In a further step of the method according to the invention, a user input is detected at the user terminal.

In particular, the input of the user is detected in response to the fact that an approach of the user terminal to the motor vehicle is detected or the input of the user is made after the approach.

The user input, which may also be referred to as user input, comprises an interaction with the user terminal and may, for example, comprise a touch input and, in particular, an actuation of one or more physical keys or buttons on the user terminal. For example, the user input comprises a single or multiple actuation of a single key or button, in particular in a predetermined pattern and/or rhythm. Alternatively or additionally, the user input comprises a single or multiple actuation of at least two different keys or buttons, in particular in a predetermined pattern and/or rhythm. The predetermined pattern and/or the predetermined rhythm can be defined or predetermined both by the user terminal and by the user.

In particular, the input may additionally or alternatively also comprise voice input and/or gesture input, as will be explained further on. In particular, however, the input does not include biometric input or is not evaluated for biometric content, as will also be explained later.

This input is used in particular to unlock and/or open the motor vehicle, or the input indicates a user's intention to unlock and/or open the motor vehicle. In particular, the motor vehicle is not unlocked and/or opened if the user approaches the motor vehicle but does not make any input, in particular irrespective of whether the user has been authenticated or not, as will also be described below.

The fact that a user input has been detected, and possibly also its type and/or content, as will be explained further on, can then be provided to the motor vehicle, in particular via a wireless communication protocol, as described above. This can be done both before and after detecting that a user of the user terminal has not been authenticated, as described below.

In a further step of the method according to the invention, it is detected that the user of the user terminal has not been authenticated.

In particular, in response to the detection of the approach and/or in response to the input of the user, it is detected that a user of the user terminal has not been authenticated.

The fact that a user has not been authenticated may in particular include the fact that a user has not been authenticated or has not been authenticated for longer than a predetermined period of time in the past, in particular before approaching and/or before entering, for example for longer than 15 s, 30 s, 60 s, 120 s or 300 s. This can be determined or queried via a wireless communication protocol, in particular between the motor vehicle and the user terminal.

In particular, detecting that the user of the user terminal has not been identified includes detecting whether the user terminal is locked or is in a locked state.

In the present case, a locked state comprises a state in which no or only limited functions of the user terminal are possible and/or, in particular, no access to safe and/or secure functions is possible, for example also to functions that are provided in an app or a program that enables interaction with the motor vehicle and that, in particular, enables unlocking functions and/or opening functions of the motor vehicle. This status can be queried via a wireless communication protocol between the motor vehicle and the user terminal and, in particular, can be provided to the motor vehicle.

In particular, a status of the user terminal is queried, which determines whether the user terminal is currently locked or was locked within a predetermined period of time in the past, in particular before approaching and/or before input, for example less than 300 s, 120 s, 60 s, 30 s or 15 s ago.

In a further step of some implementations of the method, the motor vehicle is unlocked based on the approach and the input. Alternatively or additionally, the motor vehicle is opened based on the approach and the input.

In particular, the motor vehicle is unlocked and/or opened in response to the detection of the approach of the user terminal and the input of the user and, optionally, the detection that a user of the user terminal has not been authenticated.

Taking into account the approach of the user terminal and the input of the user, at least one or more doors, windows and/or flaps are thus unlocked and/or opened, in particular actively opened, for example by one or more actuating devices, such as a servomotor, and/or a displacement device, such as a window lifter. In particular, the flap is a trunk lid or a rear or front flap, which releases a loading or storage space of the motor vehicle into which the user can place the objects they are carrying.

In addition, the motor vehicle can also be unlocked and/or opened based on or taking into account the non-authentication. In particular, the motor vehicle can be unlocked and/or opened even though the user has not been authenticated and/or even though the user terminal has not been unlocked.

In particular, both the detection of the input of the user and the non-authentication can be provided to the motor vehicle via a wireless communication protocol between the motor vehicle and the user terminal without further evaluation by the user terminal, and the motor vehicle can evaluate and process these two facts in order to unlock and/or open itself.

Alternatively or additionally, the user terminal can also evaluate and process these two facts and, based on this, provide an unlock command and/or an open command to the motor vehicle via a wireless communication protocol between the motor vehicle and the user terminal.

In particular, an approach of a user terminal is first detected, then an input of the user at the user terminal is detected, then it is detected that a user has not been authenticated and then the vehicle is unlocked and/or opened, taking into account the approach and the input and optionally the non-authentication.

However, other sequences of the method are also possible. In particular, all three steps of the detection process can be exchanged with each other and, in particular, taken into account mutually, as will be explained in detail below.

Implementations of a method according to the invention makes it possible to provide a solution for unlocking and/or opening a motor vehicle that is particularly secure on the one hand and particularly convenient on the other. In particular, the detection of the proximity and the user input enables two-factor authentication, which makes authentication of the user obsolete. This means that a user can gain access to their vehicle even without active authentication at the user terminal, without this being accessible to third parties.

According to a development, the input at the user terminal comprises voice input.

A voice input in this case is an input from the user that is based on spoken language. This voice input can, for example, be detected by one or more recording devices, such as a microphone, of the user terminal and, in particular, can also be evaluated.

In particular, the voice input comprises a predetermined activation wording, such as “Hey Siri” or “OK Google”, and optionally a voice command or a voice instruction. This voice command can also include a reference to the user's wish to unlock and/or open the vehicle or a request to do so, as will be described later, but it does not have to.

In particular, it can be concluded from the voice input itself and/or the activation wording alone, taking into account the approach, that the user wants the vehicle to be unlocked and/or opened and that this is actually carried out.

This development enables particularly convenient unlocking and/or opening. In particular, the user terminal can thus remain in a trouser pocket or handbag and receive the voice input from there, enabling secure unlocking and/or opening.

According to a development, the input at the user terminal comprises a gesture input.

A gesture input is an input from the user that is based on a movement of one or more body parts, in particular limbs, such as an arm and/or a hand of the user. This gesture input can, for example, be detected by one or more detection devices, such as an acceleration sensor and/or an image sensor, of the user terminal and, in particular, can also be evaluated.

For example, the user terminal is a smart watch and/or a wearable and the gesture input involves lifting or moving a hand or an arm, in particular one on which the smart watch or wearable is worn, further in particular to a predefined point, in a predefined path and/or over a predefined height, which is detected by an acceleration sensor.

Again, by way of example, the user terminal is a pair of smart glasses and the gesture input is a movement of a hand or an arm, in particular in the field of vision of the smart glasses, further in particular to a predefined point, in a predefined path and/or over a predefined height, which is detected by an image sensor.

Also, by way of example, the user terminal is a smartphone, phablet or tablet and the gesture input involves lifting or moving the user terminal, in particular to a predefined point, along a predefined path and/or over a predefined height, which is detected by an acceleration sensor.

In particular, this user gesture can also be a predefined gesture or a gesture set by the user, which includes an indication of the user's wish to unlock and/or open the vehicle or a request to do so, as will be described further on, but it does not have to be.

In particular, it can be concluded from the gesture input alone, taking into account the approach, that the user wants the motor vehicle to be unlocked and/or opened and that this is actually carried out.

This development also enables particularly convenient unlocking and/or opening. In particular, physical interaction, such as operating a button on the user terminal, can be dispensed with, and unlocking and/or opening can be safely enabled with a simple gesture. This further development is particularly suitable for smart watches and/or wearables.

According to a development, unlocking and/or opening takes place without authentication of the user.

In particular, the user is not authenticated at any time during the method, in particular until unlocking and/or opening and/or not within the predefined time period in the past, in particular before approaching and/or before entering, in particular not at the user terminal but also, for example, not by the motor vehicle or another device.

In particular, the user does not enter a PIN, password or passcode at any time during the method. Similarly, the user does not provide a biometric input at any time during the method and/or does not enable biometric capture or identification at any time during the method.

This further development also enables particularly convenient unlocking and/or opening. In particular, physical interaction with the user terminal can be avoided throughout the entire process.

According to a development, the input of the user on the user terminal does not include authentication.

In particular, there is no biometric evaluation of the input of the user and/or the input of the user does not include a PIN, password or passcode.

In particular, there is no evaluation of the voice input that provides an indication of the identity and/or authentication of the user.

In particular, there is also no evaluation of the gesture input that provides an indication of the identity and/or authentication of the user.

This development also enables particularly convenient unlocking and/or opening. In this way, physical interaction with the user terminal can also be avoided throughout the entire process.

According to a development, the input of the user comprises an input content and the method further comprises the step of evaluating the input content, the unlocking and/or opening of the motor vehicle being further based on the input content.

In this development, not only is the presence of a previously described user input taken into account in order to unlock the motor vehicle, in particular without authentication, but the user input also includes an input content that indicates or expresses a user request to unlock the motor vehicle.

For example, the voice input includes a voice command and/or a voice instruction that includes unlocking the vehicle. For example, the voice command is “open the vehicle” and/or “unlock the car”. The voice command can be predetermined by the vehicle and/or the user and/or determined by voice evaluation, for example with the help of artificial intelligence.

Again, by way of example, the gesture input includes a gesture command that includes or indicates unlocking the vehicle. The gesture command can be predetermined by the vehicle and/or by the user and/or determined by gesture evaluation, for example with the help of artificial intelligence.

In particular, the input content comprises a specification as to which of the one or more doors, windows and/or flaps of the motor vehicle is to be unlocked and/or opened, which is then unlocked and/or opened in response to the input content or the specification comprised thereby. For example, the input content includes opening a single one or more of the windows, in particular all of the windows, unlocking and/or opening a single door or more of the doors, in particular all of the doors, and/or unlocking and/or opening one or more of the flaps, for example only the trunk lid.

This development makes it possible to control unlocking and/or opening in a particularly precise and user-oriented manner. In particular, this makes it possible to respond particularly well to user requirements.

According to a development, the detection of an approach of a user terminal to a motor vehicle takes place in response to the detection of an input of the user at the user terminal.

According to this development, the input of the user at the user terminal is therefore detected first and only then is the approach of a user terminal to the motor vehicle detected. The detection that a user of the user terminal has not been authenticated can take place both before the input of the user at the user terminal and afterwards and before the detection of the approach of the user terminal to the motor vehicle or even afterwards.

In particular, there can be a time interval, for example 15 s, 30 s, 60 s, 120 s or 300 s, between the input of the user and the approach to the motor vehicle, during which the input of the user and in particular also the input content can be stored or buffered at the user terminal and the process can only be continued when the user approaches.

The motor vehicle can then also be unlocked and/or opened in response to and/or based on this or afterwards.

This development makes it possible for a user to make the user input before or when picking up luggage and/or a purchase, and they then no longer have to interact with the user terminal when approaching to carry out the further steps. This also enables particularly convenient unlocking and/or opening.

According to a development, the detection of a user input at the user terminal takes place in response to the detection that a user of the user terminal has not been authenticated.

According to this development, it is therefore first detected that a user of the user terminal has not been authenticated and only then is the input of the user at the user terminal detected. The detection that the user terminal is approaching the motor vehicle can take place both before the detection that a user of the user terminal could not be authenticated and afterwards and before the input of the user at the user terminal or even afterwards.

In particular, non-authentication or the fact that the user terminal is locked can be periodically queried and stored in a memory. This eliminates the need to query or check as soon as the user terminal approaches the vehicle and/or the user input is received.

The motor vehicle can then also be unlocked and/or opened in response to and/or based on this or afterwards.

This development enables particularly fast and delay-free unlocking and/or opening. This development also enables particularly convenient unlocking and/or opening.

According to a further aspect, a device for controlling access to a motor vehicle is provided.

The device, which can also be referred to as a system, comprises means which are designed to carry out a method according to any one of the preceding exemplary embodiments.

In particular, the device can comprise at least one communication means of a user terminal. Furthermore, the device may comprise a communication means of the motor vehicle. The device may also comprise the user terminal and/or the motor vehicle. The device may also comprise one or more remote computing devices with which the motor vehicle and/or the user terminal communicates, in particular via the communication means. The user terminal and/or the motor vehicle may also comprise one or more processor devices designed to perform or at least effect steps of the method or the entire method, in particular in cooperation.

With regard to the advantages of the device and its developments and their advantages, reference is made to the advantages and developments of the device explained above.

Further features of the invention can be found in the claims, the figures and the description of the figures. The features and combinations of features mentioned above in the description as well as the features and combinations of features mentioned below in the description of the figures and/or shown alone in the figures can be used not only in the combination indicated in each case, but also in other combinations or on their own.

The invention will now be explained in greater detail with reference to a preferred exemplary embodiment and with reference to the drawings, in which:

Other objects, advantages and novel features of the present invention will become apparent from the following detailed description of one or more preferred embodiments when considered in conjunction with the accompanying drawings.

### BRIEF DESCRIPTION OF THE DRAWING

FIG. 1 shows a schematic perspective view of an exemplary embodiment of a method and a device for controlling access to a motor vehicle.

DETAILED DESCRIPTION OF THE DRAWING

FIG. 1 shows a schematic perspective view of an exemplary embodiment of a method and a device 100 for controlling access to, and, in particular, for unlocking and/or opening a motor vehicle 10.

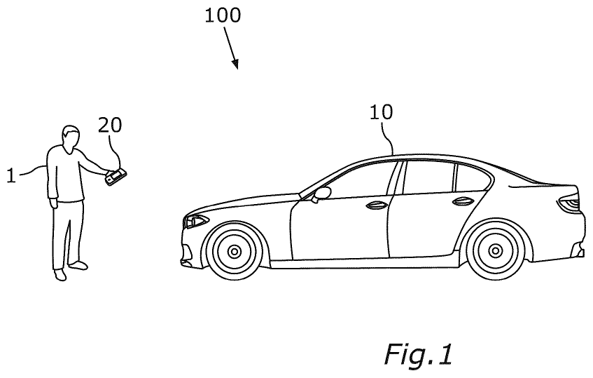

The device 100 comprises a motor vehicle 10 and a user terminal, which communicate with each other via wireless communication means not shown in detail.

In particular, the device is designed to carry out or at least effect the steps of the method described below for controlling access to the motor vehicle 10.

For this purpose, an approach of the user terminal 20 to the motor vehicle is first detected.

An input from user 1 is then detected at the user terminal 20.

The input at the user terminal 20 can include a voice input.

The input at the user terminal 20 can also include a gesture input.

However, the input of the user at the user terminal 20 may not include authentication.

It is then detected that the user of the user terminal 20 has not been authenticated.

The motor vehicle 10 is then unlocked and/or opened based on the approach and the input.

Unlocking and/or opening can take place here without authentication of the user 1.

The input can also include an input content, which can be evaluated, the motor vehicle 10 being additionally unlocked and/or opened based on the input content.

The sequence of all steps of the detection process can be changed.

In particular, the solution according to the invention makes it possible to unlock and/or open a motor vehicle using remote keyless access commands on a smartphone without a user having been authenticated.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### List of Reference Signs

1 user
10 motor vehicle
20 user terminal
100 device

What is claimed is:

1. A method for controlling access to a motor vehicle, comprising:
detecting an approach of a user terminal to a motor vehicle;
detecting an input from a user at the user terminal;
detecting that the user has not been authenticated; and
at least one of unlocking or opening the motor vehicle based on the approach and input.

2. The method according to claim 1, wherein the input at the user terminal comprises a voice input.

3. The method according to claim 1, wherein the input to the user terminal comprises a gesture input.

4. The method according to claim 1, wherein the unlocking and/or opening takes place without authentication of the user.

5. The method according to claim 1, wherein the input of the user at the user terminal does not comprise authentication.

6. The method according to claim 1, wherein:
the input comprises an input content;
the method further comprises evaluating the input content; and
the at least one of unlocking or opening of the motor vehicle is further based on the input content.

7. The method according to claim 1, wherein the detection of an approach of a user terminal to a motor vehicle takes place in response to the detection of an input of the user at the user terminal.

8. The method according to claim 1, wherein the detection of an input of the user at the user terminal is performed in response to the detection that a user of the user terminal has not been authenticated.

9. A device for access control of a motor vehicle, comprising means designed to carry a method according to claim 1.
